(19) United States
(12) Patent Application Publication
(10) Pub. No.: US 2023/0296413 A1
(43) Pub. Date: Sep. 21, 2023

(54) OPTICAL GRATING DISK, METHOD FOR IDENTIFYING Z-PHASE SIGNAL, PHOTOELECTRIC ENCODER, AND LIDAR

(71) Applicant: SUTENG INNOVATION TECHNOLOGY CO., LTD., Shenzhen (CN)

(72) Inventor: Yipeng LI, Shenzhen (CN)

(73) Assignee: SUTENG INNOVATION TECHNOLOGY CO., LTD., Shenzhen (CN)

(21) Appl. No.: 18/202,268

(22) Filed: May 25, 2023

Related U.S. Application Data
(63) Continuation of application No. PCT/CN2020/133183, filed on Dec. 1, 2020.

(51) Int. Cl. G01D 5/347

(52) U.S. Cl. CPC G01D 5/3473

(57) ABSTRACT

Embodiments of the present application disclose an optical grating disk, a method for identifying a Z-phase signal, a photoelectric encoder, and a LiDAR. At least two Z-phase etched lines are arranged on a circular disk of an optical grating disk. The method includes determining positions of a plurality of Z-phase signals collected within preset duration; identifying an abnormal Z-phase signal in the plurality of Z-phase signals based on position is of the at least two Z-phase etched lines and the positions of the Z-phase signals; and determining a position of an abnormal Z-phase etched line on the optical grating disk based on the position of the abnormal Z-phase signal when there is the abnormal Z-phase signal.

### CROSS-REFERENCE TO RELATED APPLICATION

This application is a continuation of International Application No. PCT/CN2020/133183, filed on Dec. 1, 2020. The disclosure of the aforementioned application is hereby incorporated by reference in its entirety.

### TECHNICAL FIELD

The present application relates to the field of servo motors, and in particular, to an optical grating disk, a method for identifying a Z-phase signal, a photoelectric encoder, and a LiDAR.

### TECHNICAL BACKGROUND

A photoelectric encoder is a sensor that converts mechanical geometric displacement on an output shaft of a servo motor into pulses or digital parameters by means of photoelectric conversion, which is the most widely applied sensor at present. The photoelectric encoder comprises a light source, an optical grating disk, and a photosensitive element. The optical grating disk is obtained by disposing a plurality of rectangular holes at equal intervals on a circular disk with a specific diameter. As a photoelectric grating disk is coaxial with a motor, when the motor rotates, the optical grating disk and the motor rotate at the same rate. A light receiver comprises a light-emitting diode and other electronic elements detects and outputs a plurality of pulse signals. The calculated number of pulses output by the photoelectric encoder per second can reflect the current rotation rate of the motor. In addition, to determine a direction of rotation, the code disk can also provide two pulse signals meeting a phase difference of 90, To record an absolute position of a rotating shaft, one Z-phase etched line is usually arranged on the optical grating disk. The Z-phase etched line communicates with two adjacent etched lines. The photoelectric encoder uses a Z-phase signal corresponding to the Z-phase etched line for zero calibration. However, if the surface of the optical grating disk is covered with stains or broken during use, the photoelectric encoder detects an abnormal Z-phase signal, causing a detection error.

### SUMMARY

Embodiments of the present application provide an optical grating disk, a method for identifying a Z-phase signal, a photoelectric encoder, and LiDAR, which can solve a problem of a detection error caused when Z-phase etched lines on the optical grating disk are abnormal.

According to a first aspect, an embodiment of the present application provides an optical grating disk, including:

a circular disk, where at least two Z-phase etched lines are distributed on the circular disk along a radial direction. The radial direction indicates the direction passing through an axis line in a radial plane. If the Z-phase etched lines have a length less than or equal to the radius of the circular disk, the Z-phase etched lines also correspond to one angle ranging from 0 degrees to 360 degrees. The Z-phase etched lines have a specific width. A plurality of A-phase etched lines and/or B-phase etched lines are also densely and uniformly distributed in the radial direction on the circular disk. Different types of etched lines have unequal widths.

In one possible embodiment, any two of the at least two Z-phase etched lines have unequal widths. The pulse widths of the Z-phase signals corresponding to different widths of the Z-phase etched lines are also unequal.

In a possible embodiment, the at least two Z-phase etched lines are uniformly distributed on the circular disk, that is the angular intervals of the two adjacent Z-phase etched lines are equal.

In a possible embodiment, the Z-phase etched lines have widths increasing by a preset step length, when the number of at least two Z-phase etched lines is greater than or equal to 3.

In a possible embodiment, the at least two Z-phase etched lines are non-uniformly distributed on the circular disk.

In a possible embodiment, the number of the at least two Z-phase etched lines is greater than or equal to 3, The angular intervals of the two adjacent Z-phase etched lines increase by the preset step length.

In a possible embodiment, the Z-phase etched lines have equal widths.

In a possible embodiment, the number of at least two Z-phase etched lines is 2, and the angular difference between the two Z-phase etched lines is between 30 degrees-120 degrees.

According to a second aspect, the present application provides a method for identifying a Z-phase signal, which is applied to an optical grating disk. The optical grating disk includes a circular disk. The at least two Z-phase etched lines are distributed on the circular disk along a radial direction.

The method for identifying a Z-phase signal includes:

determining positions of the plurality of Z-phase signals collected within preset duration; identifying an abnormal Z-phase signal in the plurality of Z-phase signals based on positions of the at least two Z-phase etched lines and the positions of the Z-phase signals; and

determining a position of an abnormal Z-phase etched line on the optical grating disk based on the position of the abnormal Z-phase signal when there is the abnormal Z-phase signal.

In one possible embodiment, the method for identifying a Z-phase signal further includes:

performing filtration to obtain the abnormal Z-phase signal when the plurality of Z-phase signals all are not abnormal Z-phase signals, and performing zero calibration by means of normal Z phase other than the abnormal Z-phase signals; or

outputting an alarm prompt signal when the plurality of Z-phase signals all are abnormal Z-phase signals.

According to a third aspect, the present application provides a photoelectric encoder, including a light source, an optical receiver, an optical grating disk, a processor, and a memory. The optical grating disk is arranged between the light source and the optical receiver.

The memory stores a computer program. The computer program is capable of being loaded by the processor to perform a step of the method in any one embodiment of the first aspect.

According to a fourth aspect, the present application provides LiDAR, including the forgoing photoelectric encoder.

The technical solution provided in some embodiments of the present application implements at least the following beneficial effects:

The at least two Z-phase etched lines are redundantly arranged on the optical grating disk. When there is an abnormality such as dirt on the optical grating disk, the abnormal Z-phase signal is identified via the position of the preset Z-phase etched line. The Z-phase signal generated by the abnormal Z-phase etched line can be quickly identified according to the known positions of the at least two Z-phase etched lines. Then, the zero calibration can be implemented via another normal Z-phase etched line, which can improve the reliability of the zero calibration. In addition, the position of the abnormal Z-phase etched line on the optical grating disk can be determined based on the abnormal Z-phase signal, which facilitates fault positioning and maintenance of the optical grating disk.

### BRIEF DESCRIPTION OF THE DRAWINGS

To explain embodiments of the present application or the technical solutions in the prior art more clearly, the following briefly introduces the drawings that need to be used in the embodiments or the prior art. Obviously, the drawings in the following description are only some embodiments of the present application.

FIG. 1 is a schematic structural diagram of an optical grating disk according to an embodiment of the present application;

FIG. 2 is another schematic structural diagram of an optical grating disk according to an embodiment of the present application;

FIG. 3 is a schematic flowchart of a method for identifying a Z-phase signal according to an embodiment of the present application;

FIG. 4A is a schematic structural diagram of a normal optical grating disk according to an embodiment of the present application;

FIG. 4B is a waveform diagram of a Z-phase signal and an A-phase signal generated based on an optical grating disk in FIG. 4A;

FIG. 5A is a schematic structural diagram of an abnormal optical grating disk according to an embodiment of the present application;

FIG. 5B is a waveform diagram of a Z-phase signal and an A-phase signal generated based on an optical grating disk in FIG. 5A;

FIG. 6A is a schematic structural diagram of an abnormal optical grating disk according to an embodiment of the present application,

FIG. 6B is a waveform diagram of a Z-phase signal and an A-phase signal generated based on an optical grating disk in FIG. 5A;

FIG. 7A is a schematic structural diagram of an abnormal optical grating disk according to an embodiment of the present application;

FIG. 7B is a waveform diagram of a Z-phase signal and an A-phase signal generated based on an optical grating disk in FIG. 7A; and

FIG. 8 is a schematic structural diagram of a photoelectric encoder according to an embodiment of the present application.

### DETAILED DESCRIPTION

To make objectives, technical solutions, and advantages of the present application clearer, embodiments of the present application are described in further detail below with reference to the drawings.

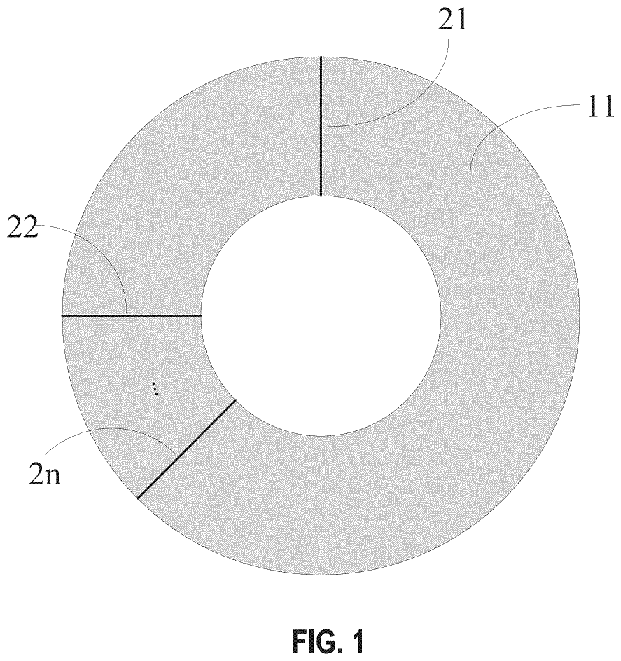

FIG. 1 is a schematic structural diagram of an optical grating disk according to an embodiment of the present application. The optical grating disk includes a circular disk 11. Herein, n Z-phase etched lines are distributed on the circular disk 11 along a radial direction, and n is an integer greater than or equal to 2. The optical grating disk can be classified as transmission type or reflection type. For the transmission-type optical grating disk, a rotation shaft of a motor is provided with the optical grating disk. The optical grating disk is provided with a plurality of slits thereon. The two sides of the optical grating disk are provided with a light source and a light receiver, respectively. The rotation shaft of the motor shaft synchronously drives the optical grating disk to rotate in the rotation process. A light signal emitted by the light source is transmitted through the slits on the optical grating disk and detected by the light receiver. The light receiver converts the detected light signal into an electrical signal, and then calculates the angular rate of the motor based on the attribute information of the electrical signal. For the reflection-type optical grating disk, a difference is that the optical grating disk is provided with a plurality of reflection strips thereon. The light source and the light receiver are arranged on the same side of the optical grating disk. The light signals emitted by the light source are detected by the light receiver via the reflection of the reflection strips. The light receiver then converts the detected light signal into the electrical signal, and calculates the angular rate of the motor according to the attribute information of the electrical signal.

For an optical grating disk which is transmission type, the Z-phase etched lines are the slits arranged on the circular disk 11. For an optical grating disk which is reflection type, the Z-phase etched lines are the reflection strips arranged on the circular disk 11. When the Z-phase signals are collected consecutive two times, the motor drives the optical grating disk to rotate by 360 degrees. The width of the Z-phase etched lines are related to that of the Z-phase signals, that is, the larger the width of the Z-phase etched lines, the larger the pulse width of the Z-phase signals. The smaller the width of the Z-phase etched lines, the smaller the pulse width of the Z-phase signals. The radial direction indicates the direction along the radius of the circular disk 11, that is, the extension lines of a Z-phase etched line 21 to a Z-phase etched line 2n all pass through the center of the circular disk 11 (not shown in FIG. 1).

The n Z-phase etched lines can be uniformly distributed on the circular disk 11 or non-uniformly distributed on the circular disk 11. Uniform distribution means that the n Z-phase etched lines divide the circumference of the circular disk 11 into n arcs equally. The angle of each arc is 360 degrees/n, for example, when n=4, the four Z-phase etched lines divide the circumference into four arcs. The angle of each arc is 90 degrees. Non-uniform distribution means that the n Z-phase etched lines divide the circumference of the circular disk 11 into n arcs. There is at least one arc with unequal angles among the n arcs. In an example, all the arcs among the n arcs have unequal angles, for example: when n=3, three Z-phase etched lines divide the circumference into three arcs. The sum of the angles of the three arcs is 360 degrees. The angles of the three arcs are distributed as 60 degrees, 120 degrees, and 180 degrees. The angles of the respective arcs are unequal.

In an example, the circular disk 11 is provided with a plurality of A-phase etched lines and/or B-phase etched lines (not shown in the figure) besides the n Z-phase etched lines. The plurality of A-phase etched lines or the plurality of B-phase etched lines are evenly distributed in the radial direction of the circular disk 11. The A-phase etched lines are configured to generate A-phase signals. The B-phase etched lines are configured to generate B-phase signals. When the circular disk 11 is provided with the A-phase etched lines and the Z-phase etched lines, since the positions of the A-phase etched lines and the Z-phase etched lines are known, the intervals of the two adjacent Z-phase signals can be indicated with the number of the A-phase signals; or when the circular disk 11 is provided with the B-phase etched lines and the Z-phase etched lines, since the positions of the B-phase etched lines and the Z-phase etched lines are known, the intervals of the two adjacent Z-phase signals can be indicated with the number of the B-phase signals; or when the circular disk 11 is provided with the A-phase etched lines, the B-phase etched lines, and the Z-phase etched lines, since the positions of the A-phase etched lines, the B-phase etched lines, and the Z-phase etched lines are known, when the intervals of the two adjacent Z-phase etched lines are indicated with the A-phase signals, if the A-phase etched lines fail, the A-phase signals are switched to the B-phase signals to indicate the intervals of the Z-phase signals. Accordingly, when the intervals of the two adjacent Z-phase signals are indicated with the B-phase signals, if the B-phase etched lines fail, the Z-phase signals are switched to the A-phase signals to indicate the intervals of the Z-phase signals, which can improve the reliability of a system.

For example, the circular disk 11 is provided with 3600 uniformly distributed A-phase etched lines and two Z-phase etched lines thereon. The two Z-phase etched lines are Z-phase etched line 21 and Z-phase etched line 22, respectively. There is a fixed position relationship between the Z-phase etched lines and the A-phase etched lines, the intervals between the Z-phase etched line 21 and the Z-phase etched line 22 can be indicated with the number of the A-phase etched lines.

In an embodiment, the at least two Z-phase etched lines are arranged on the circular disk of the optical grating disk. When there is a contamination at the Z-phase etched lines on the circular disk, including the contamination outside the existing Z-phase etched lines and the contamination on the existing Z-phase etched lines, the Z-phase signals generated by the abnormal Z-phase etched lines can be quickly identified by the distribution positions of the two Z-phase etched lines that are arranged redundantly. The zero calibration can be achieved with other normal Z-phase etched lines, which hence can improve the reliability of the zero calibration.

In one embodiment, any two of the at least two Z-phase etched lines have unequal widths. If there are at least two Z-phase etched lines, the number of the Z-phase etched lines is n, and n is an integer greater than or equal to 2. The n Z-phase etched lines are a Z-phase etched line 1, a Z-phase etched line 2, . . . , a Z-phase etched line n. The width of the n Z-phase etched lines is w1, w2, . . . wn, where the relationship between the width of the n Z-phase etched lines satisfies the following: wi≠wj, i=1, 2, . . . , n; and j=1, 2, . . . , n, where i≠j. At least two Z-phase etched lines can be uniformly or non-uniformly distributed on the circular disk 11 when the Z-phase etched lines have unequal widths. In this embodiment, widths of the Z-phase etched lines are set to different values, which can effectively identify the Z-phase signals corresponding to the Z-phase etched lines, avoid confusion among the Z-phase signals, and improve the accuracy of identifying the Z-phase signal.

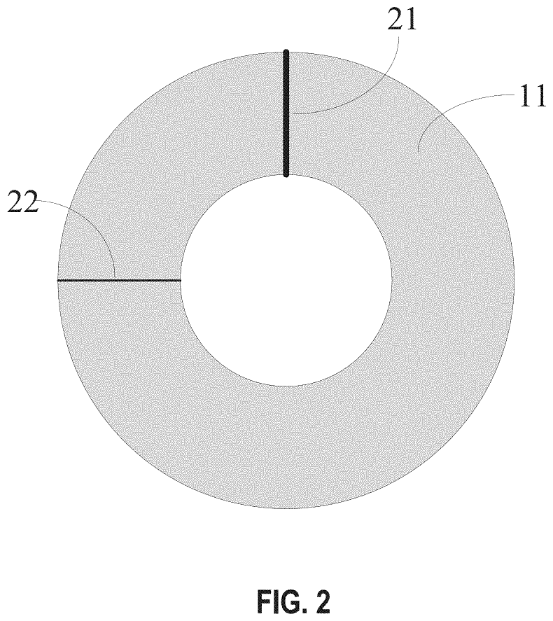

For example, referring to FIG. 2, the circular disk 11 is provided with the Z-phase etched line 21 and the Z-phase etched line 22. The Z-phase etched line 21 has a width larger than that of the Z-phase etched line 22.

Further, the Z-phase etched lines have widths increasing by a preset step length, when the number of the at least two Z-phase etched lines is greater than or equal to 3.

For example, when the number of the Z-phase etched lines arranged on the circular disk is 3, the three Z-phase etched lines are the Z-phase etched line 1, the Z-phase etched line 2, and a Z-phase etched line 3. The Z-phase etched line 1 has a width of L. The Z-phase etched line 2 has a width of L+ΔL. The Z-phase etched line 3 has a width of L+2×ΔL.

In one embodiment, the at least two Z-phase etched lines are non-uniformly distributed on the circular disk.

Non-uniform distribution means that the n Z-phase etched lines divide the circumference of the circular disk 11 into n arcs, and n is an integer greater than 2. There is at least one arc with unequal angles among the n arcs. In an example, all the arcs among the n arcs have unequal angles, for example: when n=3, three Z-phase etched lines divide the circumference into three arcs. The sum of the angles of the three arcs is 360 degrees. The angles of the three arcs are distributed as 60 degrees, 120 degrees, and 180 degrees. The angles of the respective arcs are unequal. In this embodiment, the at least two Z-phase etched lines are non-uniformly distributed on the circular disk, which can effectively identify the Z-phase signals corresponding to the Z-phase etched lines, avoid confusion among the Z-phase signals, and improve the accuracy of identifying the Z-phase signal.

Further, the number of the at least two Z-phase etched lines is greater than or equal to 3. Intervals of the two adjacent Z-phase etched lines increase by a preset step length.

The interval between the two adjacent Z-phase etched lines can be indicated with an angle or the number of A-phase etched lines or B-phase etched lines.

For example, the interval is indicated in the angle. The number of Z-phase etched lines arranged on the optical grating disk is 3. The three Z-phase etched lines are the Z-phase etched line 1, the Z-phase etched line 2, and the Z-phase etched line 3. The preset step length is 30 degrees. The angular interval between the Z-phase etched line 1 and the Z-phase etched line 2 is 90 degrees. The angular interval between the Z-phase etched line 2 and the Z-phase etched line 3 is 120 degrees. The angular interval between the Z-phase etched line 3 and the Z-phase etched line 1 is 150 degrees.

Another example: the interval is indicated by the number of A-phase etched lines. The optical grating disk is provided with the 3600 uniformly distributed A-phase etched lines thereon and provided with the three Z-phase etched lines: the Z-phase etched line 1, the Z-phase etched line 2, and the Z-phase etched line 3. The preset step length is the 300 A-phase etched lines. From a clockwise direction, the interval between the Z-phase etched line 1 and the Z-phase etched line 2 is the 900 A-phase etched lines. The interval between the Z-phase etched line 2 and the Z-phase etched line 3 is the 1200 A-phase etched lines. The interval between the Z-phase etched line 3 and the Z-phase etched line 1 is the 1500 A-phase etched lines.

The Z-phase etched lines have equal widths when the at least two Z-phase etched lines are non-uniformly distributed on the circular disk.

The number of the at least two Z-phase etched lines is 2. The angular difference between the two Z-phase etched lines is between 30 degrees and 120 degrees.

The at least two Z-phase etched lines are non-uniformly distributed on the circular disk. The angular difference between the at least two Z-phase etched lines is between 30 degrees and 120 degrees.

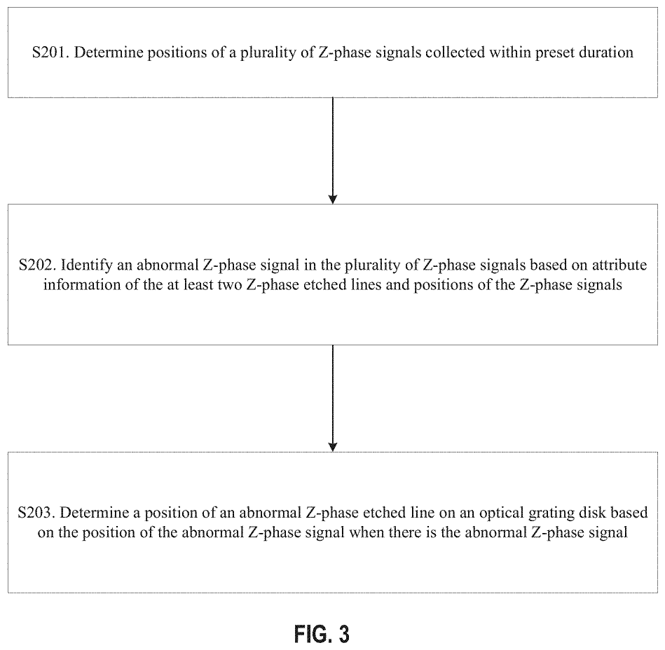

FIG. 3 is a flowchart of a method for identifying a Z-phase signal according to an embodiment of the present application. The method for identifying a Z-phase signal in an embodiment of the present application is applied to an optical grating disk of FIG. 1 and FIG. 2. For a structure of the optical grating disk, refer to the embodiment of FIG. 1 and FIG. 2. Details are not described herein again. The method includes the following.

S201. Determine the positions of a plurality of Z-phase signals collected within a preset duration.

The preset duration is greater than the duration of the rotation of a motor by 360 degrees. The preset duration has the duration of the rotation of the motor by two Cycles, to ensure that the same type of the at least two Z-phase signals are collected within the preset duration. In addition, the optical grating disk is also provided with A-phase etched lines or B-phase etched lines. The plurality of A-phase signals or B-phase signals are also collected by an optical receiver for a preset duration. The positions of the Z-phase signals can be indicated with relative positions, for example, in this embodiment, the positions of the two adjacent Z-phase signals are indicated with the number of A-phase signals or B-phase signals corresponding to the two adjacent Z-phase signals.

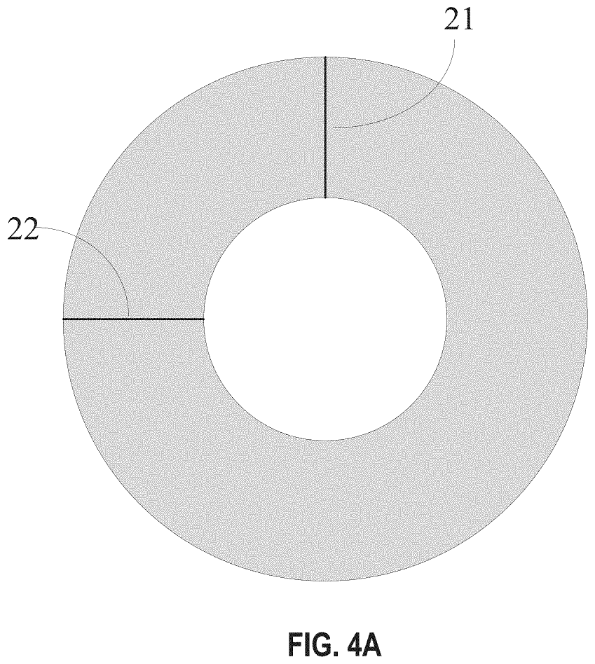

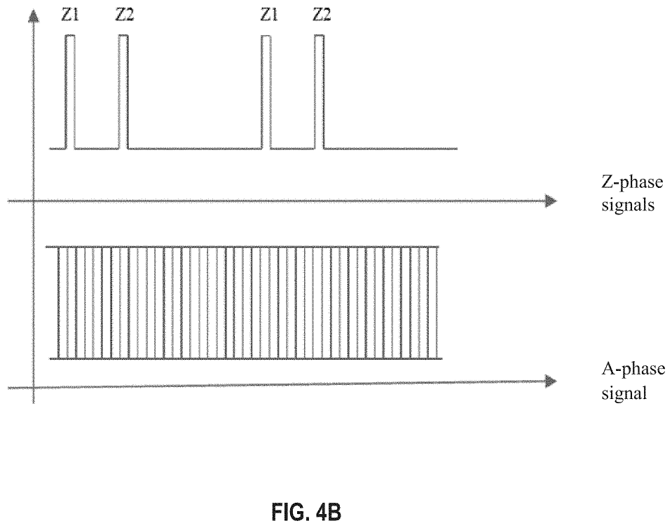

For example, referring to FIG. 4B, the four Z-phase etched lines are collected within the preset duration. The positions of the four collected Z-phase etched lines are determined as follows: the interval between first Z-phase signals and second Z-phase signals is the 900 A-phase signals. The interval between the second Z-phase signals and third Z-phase signals is the 2700 A-phase signals. The interval between the third Z-phase signals and fourth Z-phase signals is the 900 A-phase signals. Because it is known that the 3600 A-phase etched lines are distributed on the circular disk, the interval between the first Z-phase signals and the third Z-phase signals is the 3600 A-phase etched lines. Therefore, the first Z-phase signals and the third Z-phase signals correspond to the same Z-phase etched line. The Z-phase signals corresponding to the Z-phase etched lines are marked as Z1. The interval between the second Z-phase signals and the fourth Z-phase signals is the 3600 A-phase etched lines. Therefore, the second Z-phase signals and the fourth Z-phase signals correspond to the same Z-phase etched lines. The Z-phase signals corresponding to the Z-phase etched lines are marked as Z2.

S202. Identify an abnormal Z-phase signal in the plurality of Z-phase signals based on positions of the at least two Z-phase etched lines and the positions of the Z-phase signals.

S203. Determine the positions of abnormal Z-phase etched lines on the optical grating disk based on the positions of the abnormal Z-phase signals when there are the abnormal Z-phase signals.

The positions of the at least two Z-phase etched lines are pre-stored in a memory. The positions of the at least two Z-phase etched lines can be indicated with relative positions. The relative positions are indicated with the number of A-phase etched lines or B-phase etched lines between the two adjacent Z-phase etched lines.

For example, in FIG. 4A, the number of Z-phase etched lines arranged in the optical grating disk is 2: Z-phase etched line 21 and Z-phase etched line 22. The Z-phase etched lines have equal widths. The positions between the Z-phase etched line 21 and the Z-phase etched line 22 stored in the memory are indicated as: the interval between the Z-phase etched line 21 and the Z-phase etched line 22 is the 900 A-phase etched lines. The interval between the Z-phase etched line 22 and the Z-phase etched line 21 is the 2700 A-phase etched lines. When the positions of the at least two Z-phase etched lines stored in the memory match the positions of the collected Z-phase etched lines, it is indicated that the optical grating disk is normal. Otherwise, it is indicated that the circular disk is contaminated.

For example, referring to a waveform diagram of Z-phase signals shown in FIG. 4B, the four Z-phase signals and the plurality of A-phase signals are collected within preset duration. It is first determined that the pulse width of the Z-phase signals meet requirements. It is then determined that the interval between the first Z-phase signals and the second Z-phase signals is the 900 A-phase signals. The interval between the second Z-phase signals and the third Z-phase signals is the 2700 A-phase signals. The interval between the third Z-phase signals and the fourth Z-phase signals is the 2700 A-phase signals. The rotation of the optical grating disk by 360 degrees generates the 3600 A-phase signals. Therefore, the first Z-phase signals and the third Z-phase signals are generated by the same Z-phase etched line and marked as Z1. The second Z-phase signals and the fourth Z-phase signals are generated by the same Z-phase etched line and marked as Z2. The positions of the two Z-phase etched lines pre-stored in the memory are as follows: the intervals between the two adjacent Z-phase etched lines are the 900 A-phase etched lines and the 2700 A-phase etched lines. The positions of the Z-phase etched lines collected in FIG. 4B and the pre-set positions of the two Z-phase etched lines in FIG. 4A match perfectly. Therefore, the optical grating disk is normal.

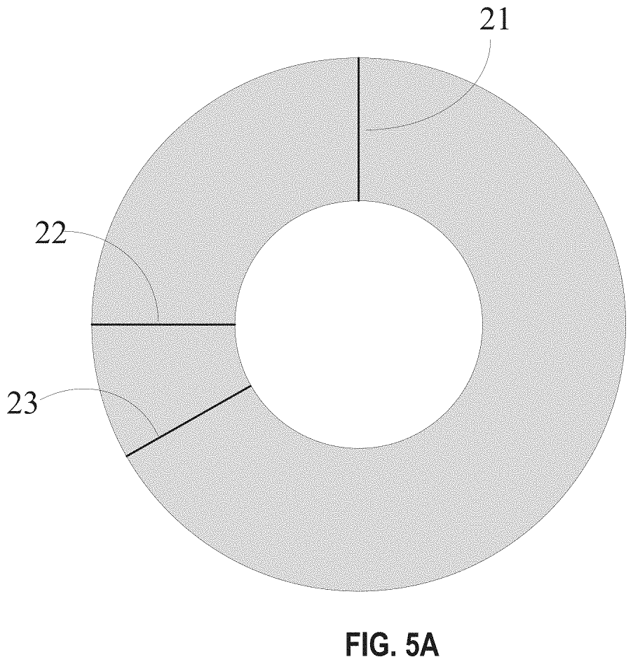

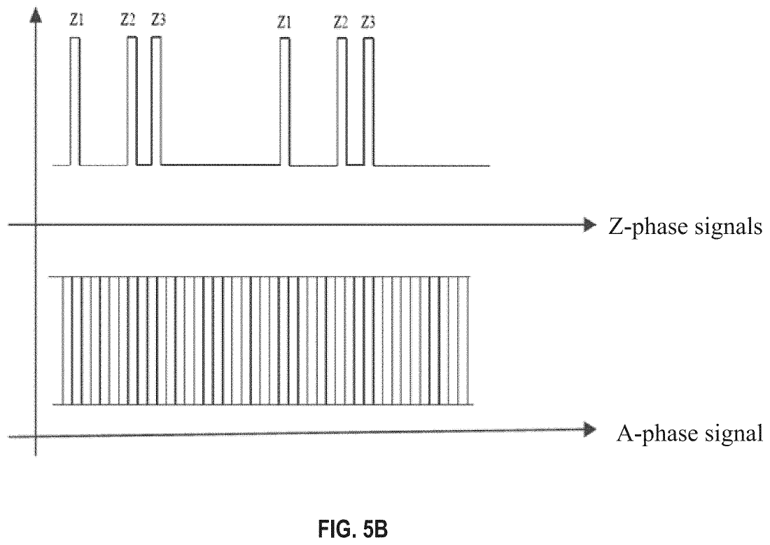

For another example, referring to FIG. 5B, which is a waveform diagram of a Z-phase signal. The six Z-phase signals and the plurality of A-phase signals are collected within a preset duration. It is first determined that the pulse width of the Z-phase signals meet requirements. It is then determined that the positions of the six Z-phase signals are as follows: the interval between the first Z-phase signals and the second Z-phase signals is the 900 A-phase signals. The interval between the second Z-phase signals and the third Z-phase signals is the 300 A-phase signals. The interval between the third Z-phase signals and the fourth Z-phase signals is the 2400 A-phase signals. The interval between the fourth Z-phase signals and fifth Z-phase signals is the 900 A-phase signals. The interval between the fifth Z-phase signals and sixth Z-phase signals is the 300 A-phase signals. The rotation of the optical grating disk by 360 degrees can generate the 3600 A-phase signals. Therefore, the first Z-phase signals and the fourth Z-phase signals are generated by the same Z-phase etched line, and are marked as Z-phase signals Z1. The second Z-phase signals and the fifth Z-phase signals are generated by the same Z-phase etched line, and are marked as Z-phase signals Z2. The third Z-phase signals and the sixth Z-phase signals are generated by the same Z-phase etched line, and are marked as Z-phase signals Z3. The positions of the two Z-phase etched lines pre-stored in the memory are as follows: the intervals between the two adjacent Z-phase etched lines are the 900 A-phase etched lines and the 2700 A-phase etched lines. The waveforms of the Z-phase signals collected in FIG. 5B are different from those collected in FIG. 4B. Therefore, it is determined that there is the abnormal Z-phase signals in the Z-phase signals collected in FIG. 5B. It is determined that the Z-phase signals Z3 are the abnormal Z-phase signals based on the correct waveform diagram of the Z-phase signals or the positions of the Z-phase etched lines stored in the memory. The abnormal Z-phase signals correspond to one abnormal Z-phase etched line on the optical grating disk. The distribution of the abnormal A-phase etched lines on the optical grating disk is shown in FIG. 5A. The interval between the abnormal Z-phase etched lines 23 and the Z-phase etched line 22 is the 300 Z-phase etched lines. The interval between abnormal Z-phase etched lines 23 and the Z-phase etched line 2I is the 2400 Z-phase etched lines.

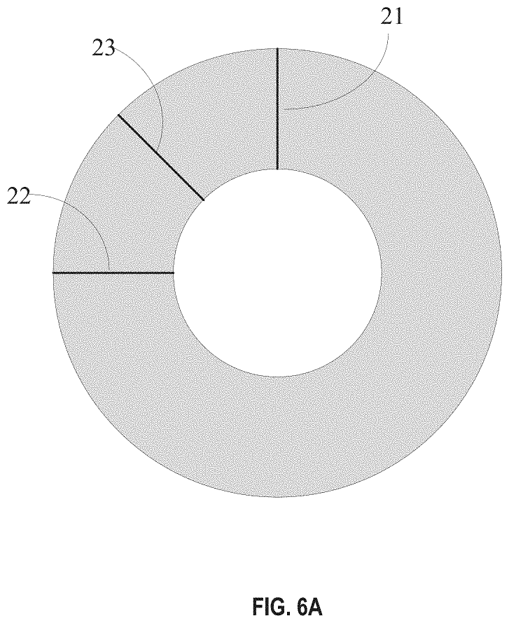

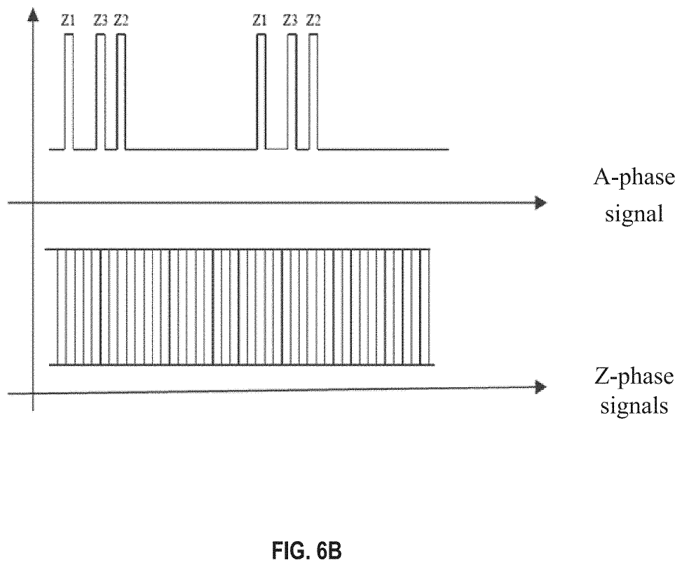

For another example, FIG. 6B is a waveform diagram of a Z-phase signal. The six Z-phase signals and the plurality of A-phase signals are collected within a preset duration. Itis first determined that the pulse width of the Z-phase signals meet requirements. It is then determined that the positions of the six Z-phase signals are as follows: the interval between the first Z-phase signals and the second Z-phase signals is the 500 A-phase signals. The interval between the second Z-phase signals and the third Z-phase signals is the 400 A-phase signals. The interval between the third Z-phase signals and the fourth Z-phase signals is the 2700 A-phase signals. The interval between the fourth Z-phase signals and fifth Z-phase signals is the 500 A-phase signals. The interval between the fifth Z-phase signals and sixth Z-phase signals is the 400 A-phase signals. It is known that the rotation of the optical grating disk by 360 degrees can generate the 3600 A-phase signals, Therefore, the first Z phase signals and the fourth Z phase signals are generated by the same Z-phase etched line, and are marked as the Z-phase signals Z1. The second Z phase signals and the fifth Z phase signals are generated by the sane Z-phase etched line, and are marked as the Z-phase signals Z2. The third Z phase signals and the sixth Z phase signals are generated by the same Z-phase etched line, and are marked as the Z-phase signals Z3. The positions of the two Z-phase etched lines pre-stored in the memory are as follows: the intervals between the two adjacent Z-phase etched lines are the 900 A-phase etched lines and the 2700 A-phase etched lines. The waveforms of the Z-phase signals collected in FIG. 6B are different from those collected in FIG. 4B. Therefore, it is determined that there is the abnormal Z-phase signals in the Z-phase signals collected in FIG. 6B. It is determined that the Z-phase signals Z3 are the abnormal Z-phase signals based on the correct waveform diagram of the Z-phase signals or the positions of the Z-phase etched lines stored in the memory. The abnormal Z-phase signals correspond to one abnormal Z-phase etched line on the optical grating disk. The distribution of the abnormal Z-phase etched lines on the optical grating disk is shown in FIG. 6A. The interval between the abnormal Z-phase etched lines 23 and the Z-phase etched line 21 is the 500 A-phase etched lines. The interval between abnormal Z-phase etched lines 23 and the Z-phase etched line 22 is the 400 A-phase etched lines.

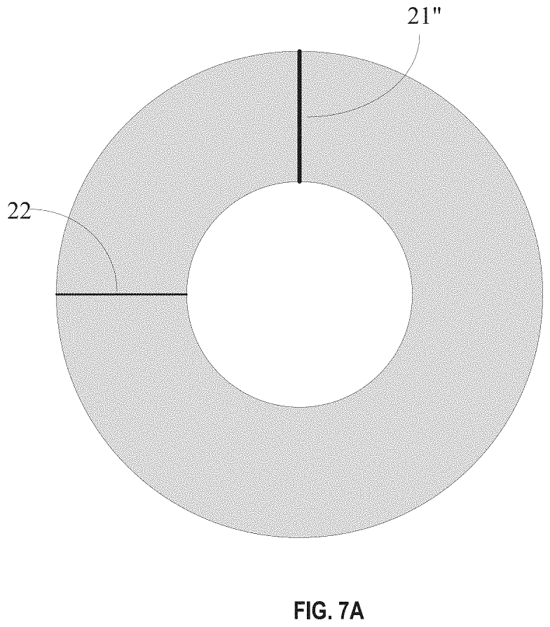

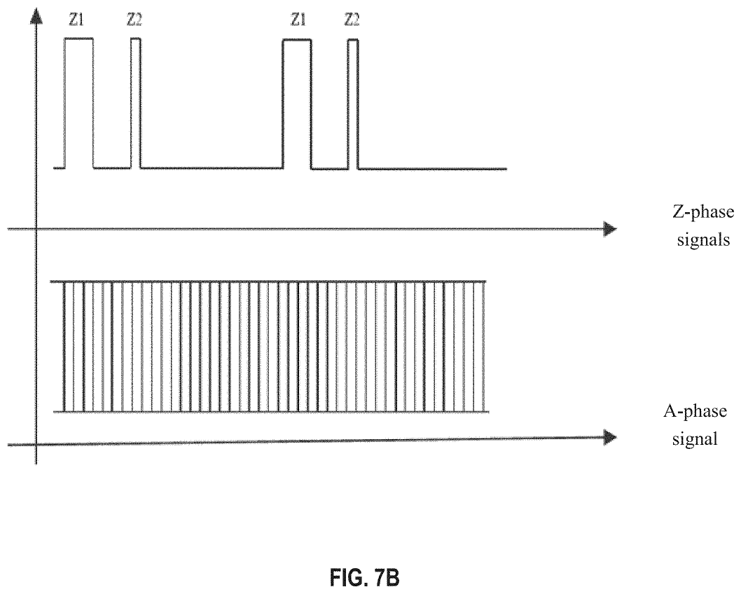

For another example, FIG. 7B is a waveform diagram of a collected Z-phase signal. The four Z-phase etched lines and the plurality of A-phase etched lines are collected within a preset duration. It is determined that the interval between the first Z-phase signals and the second Z-phase signals is the 700 A-phase etched lines. It is then determined that the pulse width of the first Z-phase signals and the third Z-phase signals are unequal to preset pulse width. It is determined that there are the abnormal Z-phase etched lines among the four Z-phase etched lines. If the interval between the first Z-phase signals and the third Z-phase signals is the 3600 A-phase signals, the first Z-phase signals and the third Z-phase signals are generated by the same Z-phase etched line, and marked as the Z-phase signals Z1. The second Z-phase signals and the fourth Z-phase signals are also generated by the same Z-phase etched line and are marked as the Z-phase signals Z2. According to the pre-stored information in the memory, the waveforms of the Z-phase signals collected in FIG. 7B are different from those collected in FIG. 4B. Therefore, it is determined that there is the abnormal Z-phase signals in the Z-phase signals collected in FIG. 7B. It is determined that the Z-phase signals Z1 are the abnormal Z-phase signals based on the correct waveform diagram of the Z-phase signals or the positions of the Z-phase etched lines stored in the memory. The abnormal Z-phase signals correspond to one abnormal Z-phase etched line on the optical grating disk. The abnormal Z-phase etched line corresponds to a Z-phase etched line 21”. The Z-phase etched line 21” covers the original position of the Z-phase etched line 21.

It should be noted that the setting modes of the Z-phase etched lines on the optical grating disk are not limited to those in FIG. 4A to FIG. 7A, but can be combined according to actual needs. A processor can identify the abnormal Z-phase signals according to the different setting modes to determine the positions of the abnormal Z-phase etched lines on the optical grating disk. For a specific process, refer to the description of FIG. 4B to FIG. 7B. Details are not described herein again.

In one embodiment, the abnormal Z-phase signals are filtered when the plurality of Z-phase signals are not all the abnormal Z-phase etched lines. Zero calibration is performed by means of a normal Z-phase other than the abnormal Z-phase signals; or an alarm signal is output when the plurality of Z-phase signals are all the abnormal Z-phase signals.

When the Z-phase signals are not all the abnormal Z-phase signals, the abnormal Z-phase signals may be additional Z-phase signals (as shown in FIG. 5B and FIG. 6B) or abnormal Z-phase signals as shown in FIG. 7B. The abnormal Z-phase signals are filtered. The zero calibration is then performed with the normal Z-phase signals. When all the collected Z-phase signals are the abnormal Z-phase signals, the zero calibration can no longer be performed normally. Then, the alarm signals are output to indicate that a user needs to carry out maintenance.

In this embodiment, the at least two Z-phase etched lines are arranged on the circular disk of the optical grating disk. When there is contamination at the Z-phase etched lines on the circular disk, including contamination outside the existing Z-phase etched lines and contamination on the existing Z-phase etched lines, the Z-phase signals generated by the abnormal Z-phase etched lines can be quickly identified by the distribution positions of the two Z-phase etched lines that are arranged redundantly. The zero calibration can be achieved with the other normal Z-phase etched lines, which hence can improve the reliability of the zero calibration.

The following is a device embodiment of the present application, which can be used to execute a method embodiment of the present application. For details undisclosed in the device embodiment of the present application, refer to the method embodiment of the present application.

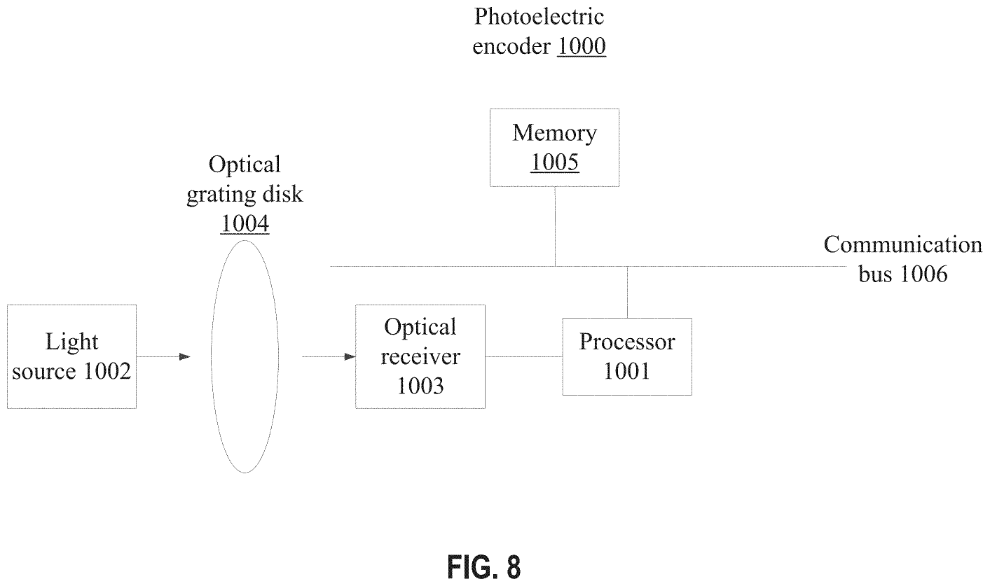

FIG. 8 is a schematic structural diagram of a photoelectric encoder according to an embodiment of the present application. As shown in FIG. 8, the photoelectric encoder is hereinafter referred to as the photoelectric encoder 1000. The embodiment is illustrated by using a projected type of a photoelectric encoder as an example. The photoelectric encoder 1000 can include at least one processor 1001, a light source 1002, an optical receiver 1003, an optical grating disk 1004, a memory 1005, and at least one communication bus 1006.

The light source 1002 is configured to emit optical signals. The optical signals are irradiated to the optical receiver 1003 via etched lines (Z-phase etched lines, A-phase etched lines, or B-phase etched lines) on the optical grating disk 1004. The optical receiver 1003 is configured to convert the received optical signals into electrical signals (that is, A-phase signals, B-phase signals, or Z-phase signals) and transmit the electrical signals to the processor 1001. For a structure of the optical grating disk 1004, refer to the description of the embodiments of FIG. 1 and FIG. 2. Details are not described herein again.

The communication bus 1006 is configured to implement connection and communication between these assemblies.

The processor 1001 can include one or more processing cores' The processor 1001 uses various interfaces and lines to connect various parts within the entire photoelectric encoder 1000 to perform various functions of the photoelectric encoder 1000 and process data by running or executing instructions, programs, code sets, or instruction sets stored in the memory 1005, and by invoking data stored in the memory 1005. In some embodiments, the processor 1001 may be implemented in at least one of the hardware forms of a digital signal processing (DSP), a field-programmable gate array (FPGA), and a programmable logic array (PLA).

The memory 1005 can include Random Access Memory (RAM) or Read-Only Memory. In some embodiments, the memory 1005 includes a non-transitory computer-readable storage medium. The memory 1005 can be configured to store instructions, programs, codes, code sets, or instruction sets. The memory 1005 can include a program storage region and a data storage region. The program storage region can store instructions for implementing an operating system, instructions for at least one function (for example, a touch control function, a sound playback function, an image playback function), instructions for implementing the method embodiments described above, and the like. The data storage region can store data involved in the method embodiments described above, etc. In some embodiments, the memory 1005 can also be at least one storage device far away from the forgoing processor 1001. As shown in FIG. 8, the memory 1005 as a computer storage medium can include the operating system, a network communication module, a user interface module, and an application program.

In the photoelectric encoder 1000 shown in FIG. 8, the processor 1001 can be configured to call application programs that are stored in the memory 1005 and that are used to configure an application program interface, and perform the steps described in the method embodiment of FIG. 3.

The embodiment and the method embodiment of FIG. 3 are based on the same conception, and achieve the same technical effect. For a specific process, refer to the description of the embodiment of FIG. 3. Details are not described herein again.

The person skilled in the art can understand that all or part of procedures in methods of the forgoing embodiments can be implemented by instructing relevant hardware via computer programs. The programs can be stored in a computer-readable storage medium. During execution, the computer programs can include the procedures of the embodiments of the forgoing methods. The storage medium can be a magnetic disk, an optical disc, the Read-Only Memory, the Random Access Memory. or the like.

An embodiment of the present application further provides a computer storage medium. The computer storage medium can store a plurality of instructions. The instructions are capable of being loaded by a processor to perform the step of the method in the embodiment shown in FIG. 3 above. For an exemplary execution process, refer to the description of the embodiment shown in FIG. 3. Details are not described herein again.

An embodiment of the present application also provides a. LIDAR, including the forgoing photoelectric encoder.

In some embodiments, a laser beam emission circuit can be applied to the LiDAR. The LiDAR can include, in addition to the photoelectric encoder, structures such as a power supply, a processing apparatus, an optical receiving apparatus, a rotating body, a base, a housing, and a human-machine interaction apparatus. It can be understood that there can be a single LiDAR, including one of the forgoing laser beam emission circuit. There can also be a plurality of LiDARs, including a plurality of the forgoing laser beam emission circuits and a corresponding control system. The specific number of LiDARs can be determined according to actual needs.

The person skilled in the art can understand that all or part of procedures in methods of the forgoing embodiments can be implemented by instructing relevant hardware via computer programs. The programs can be stored in a computer-readable storage medium. During execution, the computer programs can include the procedures of the embodiments of the forgoing methods. The storage medium can be a magnetic disk, an optical disc, the Read-Only Memory, the Random Access Memory, or the like.

What is claimed is:

1. An optical grating disk, comprising a circular disk, wherein at least two Z-phase etched lines are distributed on the circular disk along a radial direction.

2. The optical grating disk according to claim 1, wherein a width of one Z-phase etched line is different from a width of any other phase etched line.

3. The optical grating disk according to claim 2, wherein the at least two Z-phase etched lines are uniformly distributed on the circular disk.

4. The optical grating disk according to claim 1, wherein the Z-phase etched lines have widths increasing by a preset step length, when a number of the at least two Z-phase etched lines is greater than or equal to 3.

5. The optical grating disk according to claim 1, wherein the at least two Z-phase etched lines are non-uniformly distributed on the circular disk.

6. The optical grating disk according to claim 5, wherein a number of the at least two Z-phase etched lines is greater than or equal to 3, and intervals between two adjacent Z-phase etched lines increase by a preset step length.

7. The optical grating disk according to claim 6, wherein the Z-phase etched lines have equal widths.

8. The optical grating disk according to claim 1, wherein a number of the at least two Z-phase etched lines is 2, and an angular difference between the two Z-phase etched lines is between 30 degrees and 120 degrees.

9. A method for identifying a Z-phase signal, applied to an optical grating disk, wherein the optical grating disk includes a circular disk, and at least two Z-phase etched lines are distributed on the circular disk along a radial direction,
the method comprising:
determining positions of a plurality of Z-phase signals collected within preset duration;
identifying an abnormal Z-phase signal in the plurality of Z-phase signals based on positions of the at least two Z-phase etched lines and the positions of the Z-phase signals; and
determining a position of an abnormal Z-phase etched line on the optical grating disk based on the position of the abnormal Z-phase signal when there is the abnormal Z-phase signal.

10. The method according to claim 9, further comprising:
performing filtration to obtain the abnormal Z-phase signal when the plurality of Z-phase signals all are not abnormal Z-phase signals, and performing zero calibration by means of normal Z phase other than the abnormal Z-phase signals; or
outputting an alarm prompt signal when the plurality of Z-phase signals all are abnormal Z-phase signals.

11. A photoelectric encoder, comprising a light source, an optical receiver, an optical grating disk, a processor, and a memory, wherein the optical grating disk is arranged between the light source and the optical receiver; and
the memory stores a computer program, and the computer program is capable of being loaded by the processor to perform operations comprising:
determining positions of a plurality of Z-phase signals collected within preset duration;
identifying an abnormal Z-phase signal in the plurality of Z-phase signals based on positions of at least two Z-phase etched lines and the positions of the Z-phase signals; and
determining a position of an abnormal Z-phase etched line on the optical grating disk based on the position of the abnormal Z-phase signal when there is the abnormal Z-phase signal.

12. The photoelectric encoder according to claim 11, wherein the operations further comprises:
performing filtration to obtain the abnormal Z-phase signal when the plurality of Z-phase signals all are not abnormal Z-phase signals, and performing zero calibration by means of normal Z phase other than the abnormal Z-phase signals; or
outputting an alarm prompt signal when the plurality of Z-phase signals all are abnormal Z-phase signals.
